(19) United States
(12) Patent Application Publication
(10) Pub. No.: US 2016/0098693 A1
(43) Pub. Date: Apr. 7, 2016

(54) ONLINE PURCHASE WITH MOBILE PAYMENT DEVICE AND METHOD

(71) Applicants: Jack Shauh, San Diego, CA (US); Kuo-Chun Lee, San Diego, CA (US)

(72) Inventors: Jack Shauh, San Diego, CA (US); Kuo-Chun Lee, San Diego, CA (US)

(21) Appl. No.: 14/875,689

(22) Filed: Oct. 5, 2015

Related U.S. Application Data
(60) Provisional application No. 62/059,955, filed on Oct. 5, 2014.
(60) Provisional application No. 62/074,203, filed on Nov. 3, 2014.

(51) Int. Cl. G06Q 20/12; G06Q 20/32; H04W 76/02; G06Q 30/06; H04W 48/16; H04W 60/00

(52) U.S. Cl. CPC G06Q 20/12; H04W 48/16; H04W 60/00; H04W 76/023; G06Q 30/0601; G06Q 20/3227; H04W 88/02

(57) ABSTRACT

A mobile payment system includes a web browsing capable device in communication with the Internet to make purchases online at online stores, and a mobile payment device having securely stored payment information. The mobile payment device is locally or remotely connectable to the web browsing capable device to pay for online purchases. The mobile payment device includes a registration protocol employed to discover and register one or more web browsing capable device, and the mobile device is couplable to a card issuing bank to exchange payment messages.

### CROSS-REFERENCE TO RELATED APPLICATION

This application claims the benefit of U.S. Provisional Application No. 62/059,955, filed 5 Oct. 2014 and U.S. Provisional Application No. 62/074,203, filed 3 Nov. 2014.

### FIELD OF THE INVENTION

This invention relates to mobile payment systems.

More particularly, the present invention relates to mobile payment for online purchases.

### BACKGROUND OF THE INVENTION

In the payments industry, mobile payments systems are becoming more widely used. Mobile payment applications as a virtual credit/debit card are starting to be provided to smart phones. As an example, a mobile device capable of mobile payment, can be used in a point of sale (POS) terminal to pay for a sale in a retailer store. Mobile payment can provide strong security to prevent fraud by implementing EMV (Europay, MasterCard and Visa) Integrated Circuit Card Specifications for Payment Systems. Furthermore, mobile payment can provide strong security by implementing EMV Payment Tokenization Specifications.

However, the existing mobile payment cannot be used in online purchasing when the user is purchasing through a Consumer PC or other web browsing capable device and the mobile payment resides on a different mobile device. In this case, the user has to manually enter credit or debit card number on the web page of the online store, which can create security fraud because there is no strong authentication in the purchase process.

It would be highly advantageous, therefore, to remedy the foregoing and other deficiencies inherent in the prior art.

An object of the present invention is to provide a method and system of mobile payment for us with a consumer PC.

Another object of the present invention is to provide a Secure method and system of mobile payment for us with a consumer PC.

### SUMMARY OF THE INVENTION

Briefly, to achieve the desired objects and advantages of the instant invention, provided is a mobile payment system. The mobile payment system includes a web browsing capable device in communication with the Internet to make purchases online at online stores, and a mobile payment device having securely stored payment information. The mobile payment device is locally or remotely connectable to the web browsing capable device to pay for online purchases. The mobile payment device includes a registration protocol employed to discover and register one or more web browsing capable device, and the mobile device is couplable to one or more card issuing bank to exchange payment messages. The payment messages are generated by conventional mobile payment specifications such as EMV integrated circuit card specifications for payment systems, and EMV payment tokenization specifications.

Also provided is a mobile payment method to pay for an online purchase with a mobile payment device through a web browsing capable device. The method includes the steps of providing a web browsing capable device and a mobile payment device having securely stored payment information thereon. The web browsing capable device id then registered with the mobile payment device. The web browsing capable device is used in communication with the Internet to make a purchase online at an online store. The mobile payment device is locally or remotely connected to the web browsing capable device to pay for the online purchase. The mobile payment device is coupled with a card issuing bank and payment messages are exchanged between the mobile payment device and the online bank to pay for the online purchase.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is simplified block diagram of the payment system according to the present invention;

FIG. 2 is a schematic of the message exchange between a mobile payment device, a consumer PC and an online store according to the present invention;

FIG. 3 is a simplified block diagram of the payment system showing an example of the payment messages of FIG. 2 when EMV integrated circuit card specifications for payment systems are used;

FIG. 4 is a simplified block diagram of the payment system showing an example of the payment messages of FIG. 2 EMV payment tokenization specifications are used;

FIG. 5 is a simplified block diagram of the payment system showing an example of payment messages supported by a 3rd party processing server in which the online store relays or tunnels the payment messages for the mobile payment device;

FIG. 6 is a simplified block diagram of the payment system showing an example of payment messages supported by a 3rd party processing server in which the online store redirects the consumer PC to the processing server;

FIG. 7 is a simplified block diagram of the payment system showing an example of payment messages supported by a 3rd party processing server in which the mobile payment device communicates directly with the processing server;

FIG. 8 is a simplified block diagram of the payment system showing the software modules of the consumer PC and the mobile payment device; and

FIG. 9 is a schematic diagram of the message exchange between a mobile payment device and a consumer PC using the software modules.

### DETAILED DESCRIPTION OF THE PREFERRED EMBODIMENTS

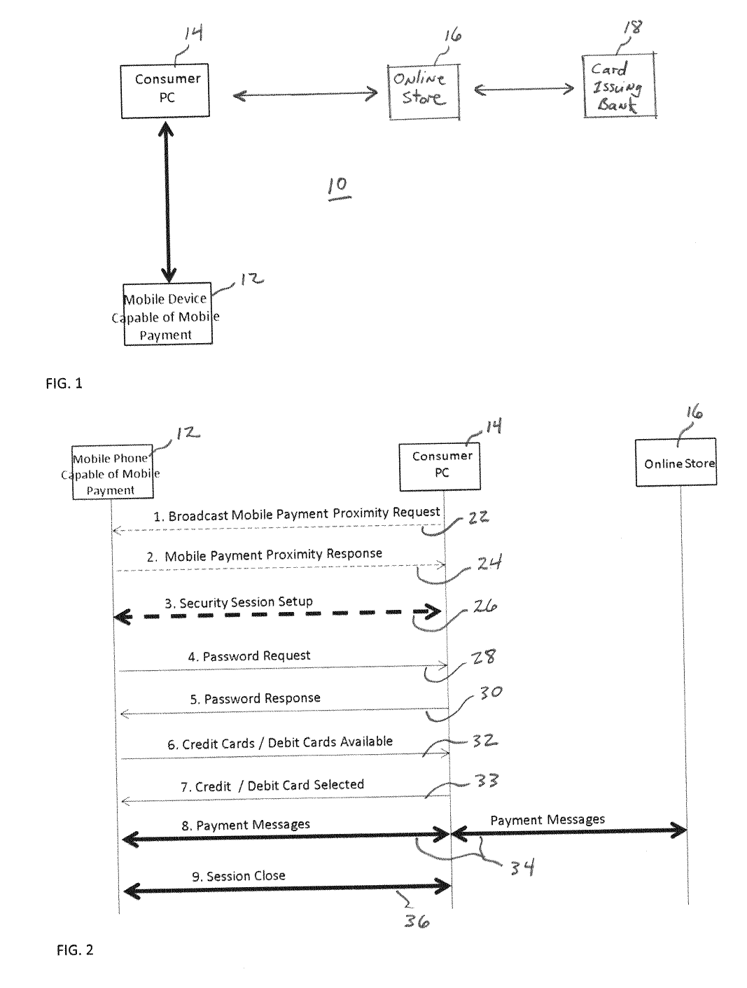

Turning now to the drawings in which like reference characters indicate corresponding elements throughout the several views, attention is first directed to FIG. 1 which illustrates a payment system 10 including a mobile payment device 12 and a consumer PC 14 (web browsing capable device). System 10 enables mobile payment device 12 to pay for online purchases at an online store 16 through consumer PC 14. It will be understood that the term online refers to communication with the Internet, a global communications network. In payment system 10, consumer PC 14 can use a wired or wireless communication link to communicate with mobile payment device 12, to locally or remotely and securely complete a payment transaction with merchant online store 16 and a card issuing bank 18. Consumer PC 14 is any personal computing platform with web browsing capability, such as a desktop PC, a laptop PC, a tablet PC, a smart phone and the like. Mobile payment device 12 is a device with computing capability and is embedded with a secure element or utilizes emulation software to emulate a secure element to securely store credit/debit card information, payment credentials, one-time credit/debit card number, payment token, etc. Mobile payment device 12 can be a smart phone, a tablet, a wearable device (e.g. watch), or even a laptop PC, embedded with a secure element or utilizes emulation software to emulate a secure element, that stores credit/debit card, payment credentials, one-time credit/debit card number, payment token, etc. The wire line communication link can be Ethernet, USB cable, Power Line, etc. The wireless communication can be Bluetooth, ZigBee, Infrared, WiFi, Mobile Network, etc. If consumer PC 14 and mobile payment device 12 are not directly connected, e.g. by USB cable, or are not connected in a local area network, e.g. by WiFi, then mobile payment device 12 may be remotely connected to consumer PC 14 using a Mobile Network for example.

In system 10, mobile payment device 12 is in the proximity of consumer PC 12 which is being used for an online purchase. A trust relationship between a user, mobile payment device 12 and consumer PC 14 must be established prior to system 10 being deemed operational. To establish a trust relationship, mobile payment device 12 has the user's credit/debit cards credential information stored therein and the user has a mobile payment device security protocol such as having configured a secure passcode for authenticating himself/herself to mobile payment device 12. The secure passcode can be in the forms of biometrics (such as fingerprint), voice recognition or password. The user of mobile payment device 12 includes a registration protocol such as with a downloaded payment application which is used to discover and register one or more consumer PCs 14 in his/her vicinity through local area network such as WiFi, Ethernet or a point to point link, such as Bluetooth, USB cable, NFC, and etc. Alternatively, optical patterns, such as bar code, or QR code can be used if both mobile payment device 12 and consumer PC 14 have camera or scanner to receive messages and display to send messages. Using the registration protocol, mobile payment device 12 will store the unique device identifier of each registered consumer PC, such as IMEI or MEID if the consumer PC is a mobile device; MAC (Medium Access Control) address of a desktop computer, laptop computer, iPad, or tablet and the like. If a consumer PC 14 has a payment application proxy installed, it should have a unique Application Proxy ID (APID). The APID may be used in conjunction with the consumer PC identifier to uniquely identify a registered consumer PC. An unregistered consumer PC must be registered with mobile payment device 12 before it can be used in system 10.

Turning now to FIG. 2, a general message exchange between mobile payment device 12 and consumer PC 14, and consumer PC 14 and online store 16, is illustrated. To provide the required functionality, both mobile payment device 12 and consumer PC 14 need to install 3rd party software to enable these messages and procedures. Online store 16 also needs some software upgrade, such as in the web page to provide a software script, to receive from 3rd party software of consumer PC 14 some data or messages as well as drop some data or messages to 3rd party software of consumer PC 14.

In this message flow, when an online purchase is desired, consumer PC 14 sends out a broadcast message mobile payment proximity request 22 to check if there is any mobile device capable of mobile payment in the proximity. For example, it can send a message using a broadcast IP address in the WiFi network. Mobile payment device 12 receives this message and replies with a mobile payment proximity response message 24. Consumer PC 14 receives message 24 and can know the communication address, such as IP address, to communicate with mobile payment device 12. If there is more than one mobile payment device 12, consumer PC 14 can prompt the user to select which mobile payment device to use.

Consumer PC 14 and mobile payment device 12 set up a secured session in order to encrypt messages in communication. This may require pre-provision with some security key between consumer PC 14 and mobile payment device 12. Alternatively, if the WiFi network can provide some security communication, then this may not be needed. It should be noted that the previous steps may be optional, especially if consumer PC 14 and mobile payment device 12 use a point to point link, such as Bluetooth, USB, NFC, or optical messaging. Mobile payment device 12 sends a password request 28 to consumer PC 14 asking the user to input a password to verify the user. Consumer PC 14 replies with a password response 30 and mobile payment device 12 verifies the password. After mobile payment device 12 verifies the password successfully, it sends credit cards/debit cards available message 32 to consumer PC 14. Consumer PC 14 displays all the available credit cards/debit cards for the user to select. Once user selects, consumer PC 14 replies with a credit/debit card selected message 33 to mobile payment device 12. Consumer PC 14 starts to forward payment messages 34 between online store 16 and mobile payment device 12. Consumer PC 14 and mobile payment device 12 close the session 36 when the transaction is terminated or completed.

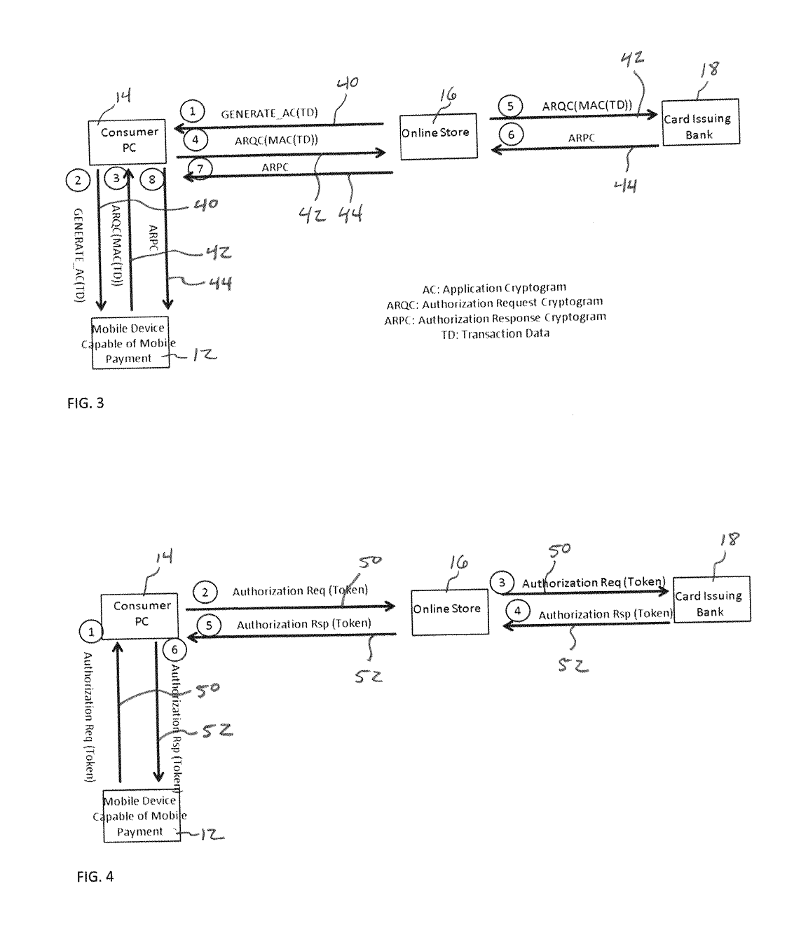

Payment messages 34 can take different forms depending on the payment technology employed. Referring to FIG. 3, an example of payment message 34 is shown for when EMV integrated circuit card specifications for system 10 are used. In this example, online store 16 sends a generate application cryptogram (AC) message 40 to consumer PC 14. Transaction Data (TD) in the message 40 has amount, date, time, etc. Consumer PC 14 forwards message 40 to mobile payment device 12. The payment application of mobile payment device 12 formats an Authorization Request Cryptogram (ARQC) message 42 which includes a Message Authentication Code (MAC) generated by the security key, TD, etc. The security key is shared between mobile payment device 12 and card issuing bank 18 in EMV online verification. Consumer PC 14 forwards ARQC message 42 to Online Store 16. Online Store 16 sends ARQC message 42 to card issuing bank 18 for online verification. After verification, card issuing bank 18 replies with an Authorization Response Cryptogram (ARPC) message 44 to online store 16. Online store 16 sends ARPC message 44 to consumer PC 14 and consumer PC 14 forwards message 44 to mobile payment device 12.

Turning now to FIG. 4, an example of payment message 34 is shown for when EMV payment tokenization specifications for system 10 are used. In this example, a mobile payment application of mobile payment device 12 sends an authorization request message 50 with Token to consumer PC 14. Consumer PC 14 forwards authorization request message 50 to online store 16. Online store 16 sends authorization request message 50 to card issuing bank 18. Card issuing bank 18 de-tokenizes to know the actual credit/debit card PAN (Primary Account Number), approve transaction and sends authorization response message 52 to online store 16. Online store 16 sends authorization response message 52 to consumer PC 14. Consumer PC 14 forwards authorization response message 52 to the payment application of mobile payment device 12. An alternative protocol to detect the presence of mobile payment device 12 can be used, e.g. UPnP (Universal Plug and Play), DLNA, Bonjour, etc. These protocols can also be used to transfer messages, data and provide security protection between mobile payment device 12 and consumer PC 14.

It is possible that the online store may not be able to provide the EMV payment messages directly. Turning now to FIG. 5, an example of payment message 34 being supported by a 3^{rd} party processing server 60, in which online store 16 relays or tunnel payment messages 34 for mobile payment device 12. A user uses consumer PC 14 to submit an online purchase message 62. Online store 16 sends a transaction request 63 to processing server 60 to process by indicating the transaction data. Processing server 60 sends a generate application cryptogram (AC) message 40 to consumer PC 14 through online store 16. Transaction Data (TD) in the message 40 has amount, date, time, etc. Consumer PC 14 forwards message 40 to mobile payment device 12. The payment application of mobile payment device 12 formats an Authorization Request Cryptogram (ARQC) message 42 which includes a Message Authentication Code (MAC) generated by the security key, TD, etc. The security key is shared between mobile payment device 12 and card issuing bank 18 in EMV online verification. Consumer PC 14 forwards ARQC message 42 to processing server 60 via online store 16. Processing server 60 sends ARQC message 42 to card issuing bank 18 for online verification. After verification, card issuing bank 18 replies with an Authorization Response Cryptogram (ARPC) message 44 to processing server 60. Processing server 60 sends ARPC message 44 to consumer PC 14 via online store 16 and consumer PC 14 forwards message 44 to mobile payment device 12. Processing server 60 replies to online store 16 with a transaction response 64.

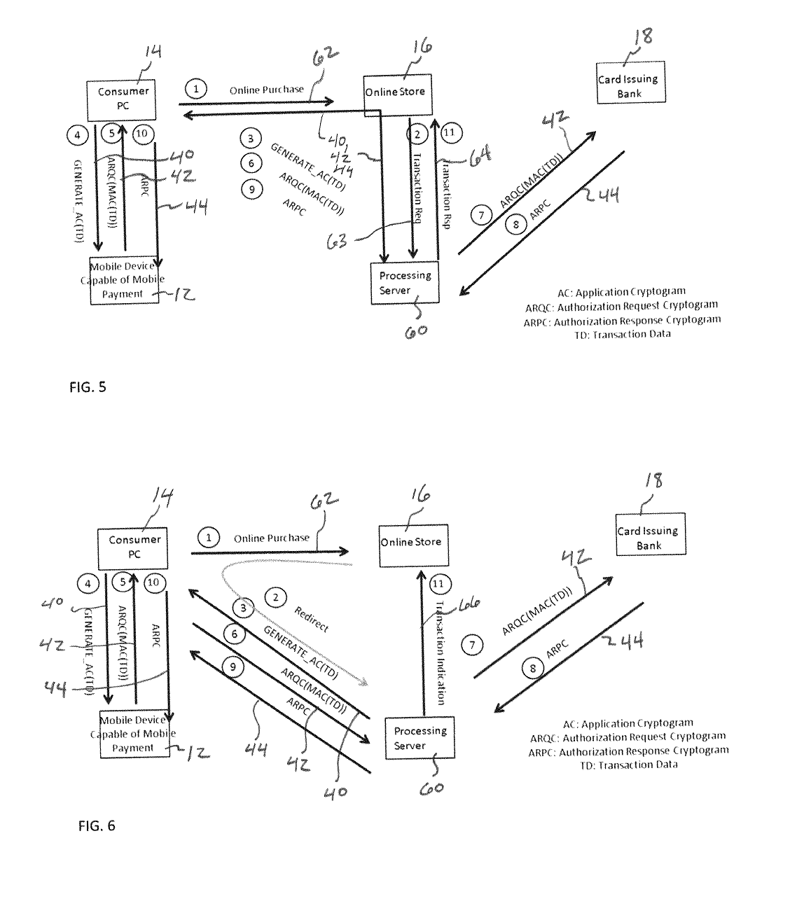

Referring now to FIG. 6, another example of payment message 34 is shown supported by 3rd party processing server 60 in which online store 16 redirects consumer PC 14 to processing server 60. This example is similar to the example of FIG. 5 with the difference being that online store 16 redirects consumer PC 14 to processing server 60 after receiving online purchase message 62, to process the purchase by indicating the address of processing server 60, such as URL address to consumer PC 14. The remaining process occurs between consumer PC 14 and processing server 60 without passing through online store 16. Processing server 60 replies to online store 16 with a transaction indication 66.

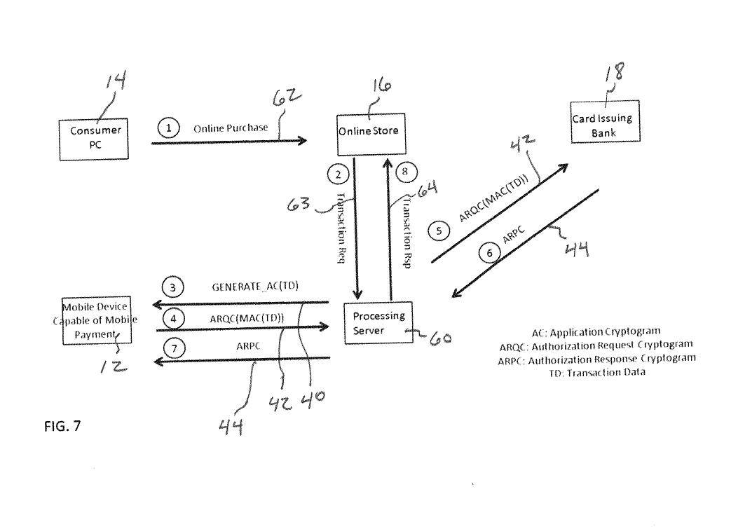

Referring now to FIG. 7, another example of payment message 34 is shown supported by 3rd party processing server 60 in which mobile payment device 12 directly communicates with processing server 60 after initiating the purchase through consumer PC 14. As with the previous example, a user uses consumer PC 14 to submit online purchase message 62 to online store 16. Online store 16 sends transaction request 63 to processing server 60 to process, indicating the mobile number or IP address or other identity of mobile payment device 12 that is provided to online store 16 in the online purchase message. Processing server 60 sends generated AC message 40 to mobile payment device 12 by knowing the mobile number, IP address or other identity of mobile payment device 12. The remaining process occurs between mobile payment device 12 and processing server 60 without passing through online store 16. Processing server 60 replies to online store 16 with a transaction response 64.

It will be understood that the above described examples can be applied when EMV Payment Tokenization Specifications or other payment technology (such as Apple Pay, Android Pay, etc.) are used in payment messages. That is, generated AC message 40, ARQC message 42 and ARPC message 44 are substituted by an authorization request and an authorization response. Payment messages used in other payment technology, e.g. Apple Pay, Android Pay and the like, may also be used for authorization request and response.

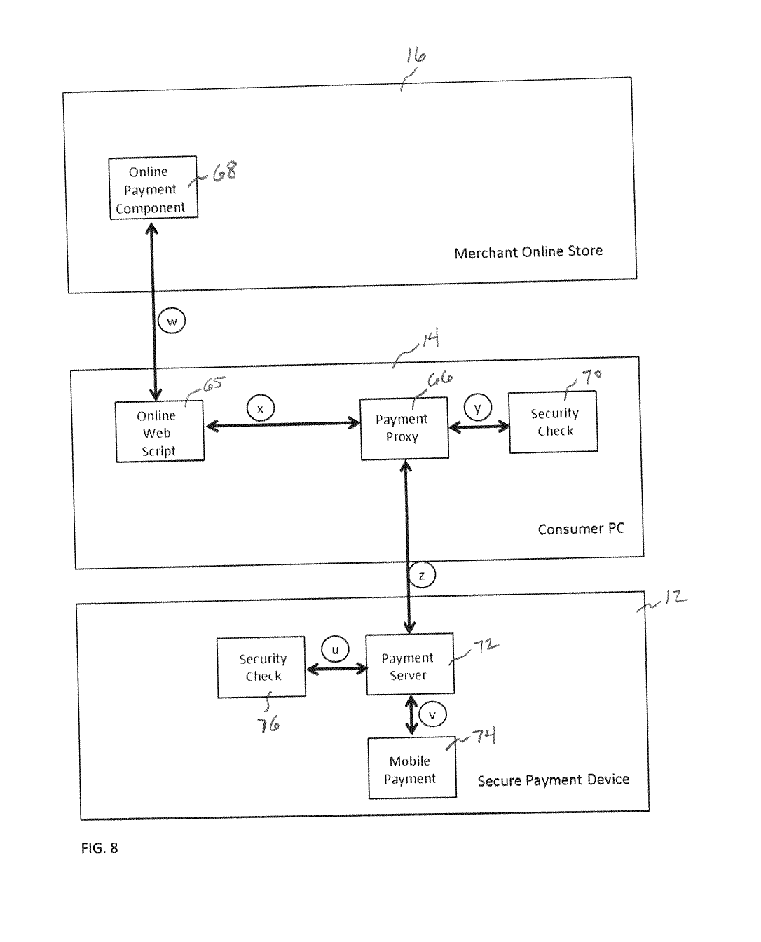

To support secure payment transactions between mobile payment device 12 and consumer PC 14, modules may be provided in mobile payment device 12 and consumer PC 14. FIG. 8 shows an example of modules of consumer PC 14 and mobile payment device 12. Consumer PC 14 includes an online web script module 65. Online web script module 65 is downloaded from an online webpage of online store 16 and can send payment data or authorization status to a payment proxy module 66 on interface x and receive payment information from payment proxy module 66 on interface x. Online web script module 65 can allow payment information to be uploaded to an online payment component module 68 of the merchant on an interface w. Payment proxy module 66 is a software application inside consumer PC 14. Payment proxy module 66 provides a communication relay between online web script module 65 on interface x and mobile payment device 12 on an interface z. Payment proxy module 66 can discover any available mobile payment device 12 in the local area network. A security check 70 is optional and can be used by payment proxy module 66 on an interface y to authenticate online web script module 65 so that payment proxy module 66 will not leak payment information to any undesirable entity in the Internet. However, if this function is implemented in payment proxy module 66, then a separate Security Check module is not required.

Inside mobile payment device 12 is a payment server module 72 which is a software application inside mobile payment device 12. Payment server module 72 receives a payment request from consumer PC 14 and replies with a payment response on interface z. Payment server module 72 can call payment module 74 on interface v. Payment server module 72 can respond to discovery requests from payment proxy module 66. A security check module 76 can be used by payment server module 72 to authenticate payment proxy 66 of consumer PC 14 on interface u to ensure only a valid consumer PC 14 can request for payment. However, if this function is implemented in the payment server as security check 70, then a separate security check module 76 is not needed. Payment module 74 provides the EMV protocol to provide payment information or payment token toward online merchant 16 via payment server module 72 on API interface z. Payment module 74 can store the credit/debit card, payment credentials, one-time credit/debit card number, payment token, etc.

Inside merchant online store 16 is online payment component module 68 which downloads online web script 65 through interface w. Online payment component module 68 receives the payment information from payment proxy module 66 through the execution of online web script. Optionally, online payment component module 68 may exchange security protocol with payment proxy 66 for mutual authentication through the execution of online web script. On interface x, online web script can communicate with payment proxy module 66 using TCP/UDP protocol with HTTP(S). The TCP/UDP port number can be pre-known between these two entities. Alternatively, online web script 65 can send to a local HTTP/URL addressed to payment proxy 66 or payment server 72. If the destination is payment server 72, payment proxy 66 only relays the HTTP(S) message. On interface z, payment proxy 66 and payment server 72 can communicate TCP/UDP protocol with HTTP(S). Payment proxy 66 can detect IP address of payment server 72 with a discovery procedure, e.g. broadcasting the presence request from payment proxy 66.

Security check 70 of consumer PC 14 or security check 76 of the mobile payment device 12 can be used to authenticate that the online web script 65 is originated from a trusted online payment component 68. For example, the message sent by online web script 65 is security signed by online payment component 68 and can be verified by payment proxy 66 and/or payment server 72 by using the pre-installed certificate (public key) of online payment component 68. Furthermore, the public key in the certificate can be used by payment proxy 66 and/or payment server 72 to encipher uplink message or data or decipher downlink message or data. Alternatively, a shared secret for the payment transaction can be delivered to payment proxy 66 and/or payment server 72 through a public key/private key method. Furthermore, security check 76 can authenticate the user by requesting user to enter a PIN code (or Passcode).

A list of home consumer PCs 14 can be pre-registered by the user to mobile payment device 12. Any device outside of this list is considered a foreign consumer PC. A consumer PC can be identified by its logical machine name (such as a name assigned by the owner of consumer PC; for example: Smith's PC), or the MAC address of its network interface card, or the payment proxy ID of corresponding payment proxy 66 software installed in consumer PC 14, or the MEID or the IMEI or any of the combination. If consumer PC 14 uses WiFi to connect to mobile payment device 12, then checking of home WiFi network can be needed. The home WiFi network can be identified by BSS ID and/or MAC Address of the home router (or home Access Point—AP) that is pre-registered by the user to mobile payment device 12.

To balance security and user convenience, security check 76 may implement a number of policies. Any foreign Consumer PC is not allowed access to mobile payment device 12. If the local link, such as USB cable, Bluetooth, or Infrared, is used to connect between consumer PC 14 and mobile payment device 12, then user authentication may not be required. When consumer PC 14 and mobile payment device 12 are in the home WiFi network and the home WiFi network is secured by WiFi security protocol, such as WEP, WPA, or WPA2, user authentication may not be required. When mobile payment device 12 is in the home WiFi network but consumer PC 14 is not in the home WiFi network, user authentication is required. In certain environment configurations, a home network may comprise a list of pre-registered WiFi BSS IDs and/or MAC Addresses; if the home network is secured by WiFi security protocol, then the user authentication for a home consumer PC user may not be required. When mobile payment device 12 is outside of an allowable GPS position of home location or is outside of a pre-registered list of allowable positions, user authentication of any home consumer PC is required.

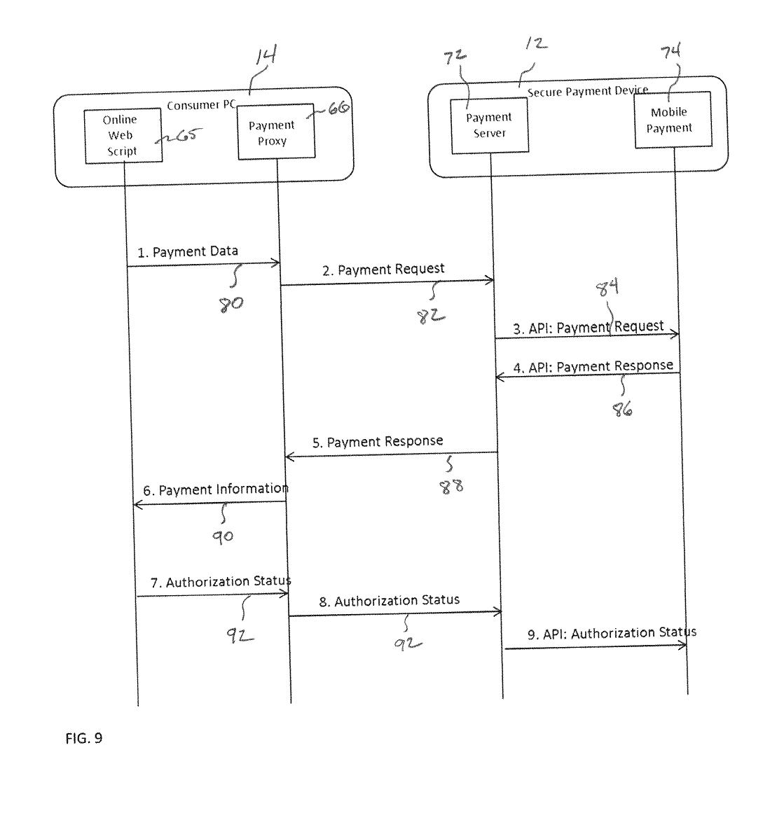

Turning to FIG. 9, an example of the messages exchanged between the modules of consumer PC 14 and mobile payment device 12 is illustrated. Online web script module 65 sends payment data 80 to payment proxy module 66. Payment data 80 may include dollar amount charged, etc. payment proxy 66 sends a payment request message or data 82 to payment server 72. Payment server 72 sends payment module 74 a payment request API 84. Payment module 74 replies with a payment response API 86. Payment server 72 sends payment response 88 to payment proxy 66. Payment proxy 66 can send payment information 90 to online web script 65 which uploads to the online merchant 16. Online web script 65 receives authorization Status 92 from the merchant and forwards to payment proxy 66. Payment proxy 66 forwards authorization status 92 to payment server 72. Payment server 72 calls Authorization Status API to signal Mobile Payment.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A mobile payment system comprising:
a web browsing capable device in communication with the Internet to make purchases online at online stores;
a mobile payment device having securely stored payment information, the mobile payment device locally or remotely connectable to the web browsing capable device to pay for online purchases;
the mobile payment device includes a registration protocol employed to discover and register one or more consumer PCs; and
wherein the mobile device is couplable to a card issuing bank to exchange payment messages.

2. A system as claimed in claim 1 wherein the registration protocol determines and stores a unique device identifier within the mobile payment device for each registered web browsing capable device.

3. A system as claimed in claim 1 wherein the mobile payment device includes a security protocol for determining access thereto.

4. A system as claimed in claim 1 wherein the mobile payment device is couplable to the card issuing bank through the web browsing capable device.

5. A system as claimed in claim 1 wherein the mobile payment device is initially couplable to the card issuing bank through the web browsing capable device, then is switched to communicate with a processing server used by the online store.

6. A system as claimed in claim 1 wherein the payment messages are generated by one of EMV integrated circuit card specifications for payment systems, EMV payment tokenization specifications, Apple Pay, and Android Pay.

7. A mobile payment method comprising the steps of:
providing a web browsing capable device;
providing a mobile payment device having securely stored payment information thereon;
registering the web browsing capable device with the mobile payment device;
using the web browsing capable device in communication with the Internet to make a purchase online at an online store;
locally or remotely connecting the mobile payment device to the web browsing capable device to pay for the online purchase;
coupling the mobile payment device with a card issuing bank; and
exchanging payment messages between the mobile payment device and the online bank to pay for the online purchase.

8. A method as claimed in claim 7 wherein the step of registering the web browsing capable device includes storing a unique device identifier within the mobile payment device for the registered web browsing capable device.

9. A method as claimed in claim 7 wherein the step of locally or remotely connecting the mobile payment device to the web browsing capable device includes the step of authenticating a user of the mobile payment device by satisfying a security protocol of the mobile payment device.

10. A method as claimed in claim 9 wherein the step of satisfying the security protocol includes inputting a secure password.

11. A method as claimed in claim 7 wherein the step of coupling the mobile payment device with a card issuing bank includes coupling the mobile payment device through the web browsing capable device to the online store.

12. A method as claimed in claim 7 wherein the step of coupling the mobile payment device with a card issuing bank includes initially coupling the mobile payment device to the card issuing bank through the web browsing capable device, then switching to communicate with a process server used by the online store.

13. A method as claimed in claim 7 wherein the step of exchanging payment messages between the mobile payment device and the online bank includes using one of EMV integrated circuit card specifications for payment systems, and EMV payment tokenization specifications.
